(19) United States
(12) Patent Application Publication
(10) Pub. No.: US 2022/0152565 A1
(43) Pub. Date: May 19, 2022

(54) PRODUCING METHOD AND PRODUCING DEVICE OF EMULSION

(71) Applicant: NITTO DENKO CORPORATION, Ibaraki-shi, Osaka (JP)

(72) Inventors: Hajime Fukunaga, Ibaraki-shi, Osaka (JP); Masashi Miyake, Ibaraki-shi, Osaka (JP)

(73) Assignee: NITTO DENKO CORPORATION, Ibaraki-shi, Osaka (JP)

(21) Appl. No.: 17/599,197

(22) PCT Filed: Mar. 6, 2020
(86) PCT No.: PCT/JP2020/009604

§ 371 Date: Sep. 28, 2021

(30) Foreign Application Priority Data
Mar. 29, 2019 (JP) 2019-066150

(51) Int. Cl. B01F 25/50; B01F 23/41; B01F 25/40

(52) U.S. Cl. CPC B01F 25/50; B01F 25/40; B01F 23/4105

(57) ABSTRACT

The present invention provides a method of manufacturing an emulsion that is more excellent in monodispersibility by a membrane emulsification method. The manufacturing method for an emulsion of the present invention is a manufacturing method for an emulsion, including circulating a mixed liquid containing a water phase and an oil phase in a circulation circuit including a plurality of tanks, a porous body, a liquid-delivering means, and circulation pipes configured to connect the tanks, the porous body, and the liquid-delivering means so that the mixed liquid passes through the porous body a plurality of times, wherein a tank to supply the mixed liquid to the circulation pipes toward the porous body and a tank to recover the mixed liquid that has passed through the porous body are different tanks.

### TECHNICAL FIELD

The present invention relates to a method and apparatus for manufacturing an emulsion.

### BACKGROUND ART

A mechanical emulsification method has been widely known as a manufacturing method for an emulsion. In general, however, according to the mechanical emulsification method, there is a tendency that the particle diameter distribution of a dispersoid (liquid droplets) in the emulsion to be obtained is wide (the monodispersibility of the dispersoid is low). In contrast, a microchannel emulsification method, a membrane emulsification method, or the like has been known as a manufacturing method for an emulsion in which the particle diameter distribution of its dispersoid (liquid droplets) is narrow (the monodispersibility thereof is high) (Patent Literatures 1 to 4).

According to the microchannel emulsification method, an emulsion excellent in monodispersibility is obtained, but the degree of freedom in designing a ratio between its dispersoid and dispersion medium is low. Meanwhile, according to the membrane emulsification method, a ratio between the dispersoid and dispersion medium of an emulsion to be obtained can be relatively freely designed, but the monodispersibility of the emulsion to be obtained is susceptible to further improvement.

FIG. 5 is a schematic view for illustrating a related-art manufacturing apparatus for an emulsion based on the membrane emulsification method. A manufacturing apparatus 200 illustrated in FIG. 5 includes: a tank 10 for storing a mixed liquid containing a water phase and an oil phase; a porous body 20 for passing the mixed liquid therethrough to emulsify the water phase and the oil phase; a liquid-delivering means 30 for delivering the mixed liquid; and circulation pipes 40 for connecting these components to form a circulation circuit.

According to a manufacturing method for an emulsion including using the manufacturing apparatus 200, the mixed liquid containing the water phase and the oil phase is supplied from the tank 10 to the circulation pipes 40 to pass through the porous body 20, and the mixed liquid that has passed through the porous body 20 is recovered in the tank 10 again. After the supply of the mixed liquid from the tank 10 to the circulation pipes 40, the passage thereof through the porous body 20, and the recovery thereof in the tank 10 have been repeated a predetermined number of times, the resultant emulsion is recovered in an emulsion-storing tank 60. As described above, the emulsion obtained by the manufacturing method is superior in monodispersibility of its liquid droplets to that obtained by the mechanical emulsification method, but may be inferior therein to that obtained by the microchannel emulsification method, and is hence susceptible to further improvement.

### CITATION LIST

### Patent Literature

[PTL 1] JP 6444062 B2
[PTL 2] JP 6115955 B2
[PTL 3] JP 2010-190946 A
[PTL 4] JP 5168529 B2

### SUMMARY OF INVENTION

### Technical Problem

The present invention has been made to solve the above-mentioned problems of the related art, and a primary object of the present invention is to provide a method of manufacturing an emulsion that is more excellent in monodispersibility by a membrane emulsification method.

### Solution to Problem

The inventors of the present invention have made an investigation on a cause for a reduction in monodispersibility of liquid droplets in an emulsion in the above-mentioned related-art manufacturing method for an emulsion. As a result, the inventors have obtained the following assumption. Specifically, according to the manufacturing method, the mixed liquid after the passage through the porous body is recovered in the tank 10 for storing the mixed liquid before the passage. The tank 10 typically includes a stirring blade 12, and the mixed liquid before the passage and the mixed liquid after the passage are mixed in the tank 10. As a result, the mixed liquid before the passage is brought into the state of being diluted with the mixed liquid after the passage. The mixed liquid after the dilution is supplied to the circulation pipes, and passes through the porous body. After that, the liquid is returned to the tank 10 to dilute the remaining mixed liquid (mixed liquid after the dilution) again. Accordingly, even when the mixed liquid is circulated so as to pass through the porous body a plurality of times, part of the mixed liquid may stay in the tank without being supplied from the tank even once. In addition, the number of times that another part of the mixed liquid passes through the porous body may be smaller than the intended number of times of passage. Such difference in number of times of passage through the porous body results in the formation of liquid droplets having different dispersed states. As a result, in the emulsion obtained by the manufacturing method, variation in particle diameter distribution of its liquid droplets may occur.

In addition, as another example of the related-art manufacturing method for an emulsion, there has been known a method including alternately passing the mixed liquid containing the water phase and the oil phase through both the left and right sides of the porous body to disperse its liquid droplets in a continuous phase. However, as in the above-mentioned manufacturing method, such manufacturing method may provide an emulsion containing liquid droplets different from each other in number of times of passage through the porous body (consequently, liquid droplets having different dispersed states).

With regard to the related-art manufacturing method for an emulsion, the inventors of the present invention have found that an emulsion excellent in monodispersibility of its liquid droplets is obtained by: using a circulation circuit including two or more tanks; and making a tank (supply tank) to supply the mixed liquid toward the porous body and a tank (recovery tank) to recover the mixed liquid after its passage through the porous body different from each other. Thus, the inventors have completed the present invention.

That is, according to one aspect of the present invention, there is provided a manufacturing method for an emulsion, including circulating a mixed liquid containing a water phase and an oil phase in a circulation circuit including a plurality of tanks, a porous body, a liquid-delivering means, and circulation pipes configured to connect the tanks, the porous body, and the liquid-delivering means so that the mixed liquid passes through the porous body a plurality of times, wherein a tank to supply the mixed liquid to the circulation pipes toward the porous body and a tank to recover the mixed liquid that has passed through the porous body are different tanks.

In one embodiment, the plurality of tanks include a first tank and a second tank connected in parallel, and the circulating the mixed liquid includes (a) supplying the mixed liquid from the first tank to the circulation pipes toward the porous body, followed by recovery of the mixed liquid that has passed through the porous body in the second tank, (b) switching the tank to supply the mixed liquid to the circulation pipes to the second tank and switching the tank to recover the mixed liquid that has passed through the porous body to the first tank at any time point when a remaining amount of the mixed liquid in the first tank becomes 10% or less of an entirety of the mixed liquid, (c) supplying the mixed liquid from the second tank to the circulation pipes toward the porous body, followed by recovery of the mixed liquid that has passed through the porous body in the first tank, and (d) switching the tank to supply the mixed liquid to the circulation pipes to the first tank and switching the tank to recover the mixed liquid that has passed through the porous body to the second tank at any time point when a remaining amount of the mixed liquid in the second tank becomes 10% or less of the entirety of the mixed liquid.

In one embodiment, the circulating the mixed liquid includes alternately repeating the (a) and the (b), and the (c) and the (d).

In one embodiment, the plurality of tanks include a first tank and a second tank connected in series, and the circulating the mixed liquid includes supplying the mixed liquid from the first tank to the circulation pipes toward the porous body, followed by recovery of the mixed liquid that has passed through the porous body in the second tank, and transferring the mixed liquid from the second tank to the first tank.

In one embodiment, the mixed liquid is a preliminarily dispersed liquid having preliminarily dispersed therein the water phase and the oil phase.

In one embodiment, the manufacturing method is a manufacturing method for an oil-in-water emulsion having oil droplets dispersed in a water phase thereof.

In one embodiment, the circulating the mixed liquid is performed so that the mixed liquid passes through the porous body 3 or more times.

According to another aspect of the present invention, there is provided a manufacturing apparatus for an emulsion, including: two or more tanks to store a mixed liquid containing a water phase and an oil phase; a porous body to pass the mixed liquid therethrough to emulsify the water phase and the oil phase; a liquid-delivering means for delivering the mixed liquid; and circulation pipes configured to connect the tanks, the porous body, and the liquid-delivering means to form a circulation circuit, wherein the two or more tanks include two or more tanks connected in parallel, wherein a downstream side of the two or more tanks connected in parallel has arranged thereon a supply tank-switching means for switching a tank to supply the mixed liquid to the circulation pipes, and wherein an upstream side of the two or more tanks connected in parallel has arranged thereon a recovery tank-switching means for switching a tank to recover the mixed liquid from the circulation pipes.

In one embodiment, the supply tank-switching means and the recovery tank-switching means are configured so as to be capable of switching the tanks so that the tank to supply the mixed liquid and the tank to recover the mixed liquid are different tanks.

According to still another aspect of the present invention, there is provided a manufacturing apparatus for an emulsion, including: two or more tanks to store a mixed liquid containing a water phase and an oil phase; a porous body to pass the mixed liquid therethrough to emulsify the water phase and the oil phase; a liquid-delivering means for delivering the mixed liquid; and circulation pipes configured to connect the tanks, the porous body, and the liquid-delivering means to form a circulation circuit, wherein the two or more tanks include two or more tanks connected in series.

In one embodiment, the manufacturing apparatus for an emulsion further includes a means for estimating an amount of the mixed liquid stored in each of the tanks.

### Advantageous Effects of Invention

According to the manufacturing method of the present invention, when the mixed liquid containing the water phase and the oil phase is circulated in the circulation circuit having interposed therein the porous body to be subjected to membrane emulsification, the mixed liquid after its membrane treatment is kept in the tank different from that of the mixed liquid before the membrane treatment, and after a predetermined amount or more of the mixed liquid before the membrane treatment has been supplied to the circulation circuit, the mixed liquid after the membrane treatment is supplied from the different tank to the circulation circuit. As described above, when the place where the mixed liquid is kept is switched before and after the membrane treatment, from which the mixed liquid is sequentially supplied to the circulation circuit, the mixing of the mixed liquid before the membrane treatment and the mixed liquid after the membrane treatment is avoided (or suppressed) as the entire system, and hence the mixed liquid after the membrane treatment follows the mixed liquid before the membrane treatment. As a result, the mixed liquid is prevented from staying in the tank, and hence variation in number of times of the membrane treatment is suppressed. Thus, an emulsion excellent in monodispersibility of its liquid droplets can be obtained.

### BRIEF DESCRIPTION OF DRAWINGS

FIG. 1 is a schematic view for illustrating an example of a manufacturing apparatus for an emulsion of the present invention.

FIG. 2 is an example of a flow chart of a manufacturing method for an emulsion of the present invention.

FIG. 3 are schematic views for illustrating the manufacturing method for an emulsion illustrated in the flow chart of FIG. 2.

FIG. 4 is a schematic view for illustrating an example of the manufacturing apparatus for an emulsion of the present invention.

FIG. 5 is a schematic view for illustrating an example of a related-art manufacturing apparatus for an emulsion.

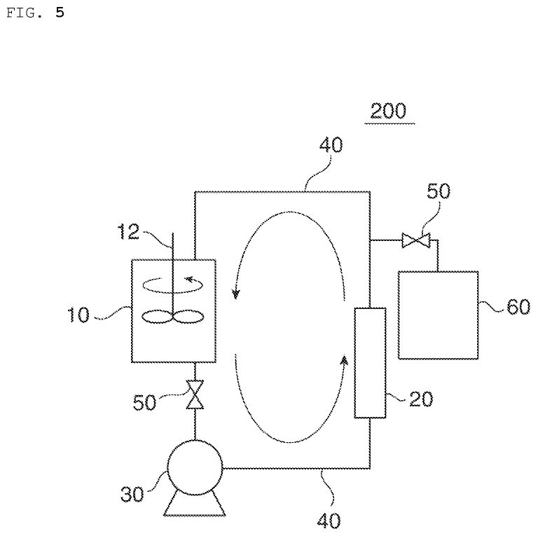

FIG. 6 includes graphs for showing the evaluation results of the particle diameter distributions of liquid droplets in emulsions obtained in Example and Comparative Example.

### DESCRIPTION OF EMBODIMENTS

Preferred embodiments of the present invention are described below. However, the present invention is not limited to these embodiments.

A manufacturing method for an emulsion of the present invention is a manufacturing method for an emulsion including circulating a mixed liquid containing a water phase and an oil phase in a circulation circuit including a plurality of tanks, a porous body, a liquid-delivering means, and circulation pipes for connecting these components so that the mixed liquid passes through the porous body a plurality of times, and one feature of the method lies in that a tank (supply tank) for supplying the mixed liquid to the circulation pipes toward the porous body and a tank (recovery tank) for recovering the mixed liquid that has passed through the porous body are different tanks. The number of times that the mixed liquid passes through the porous body may be twice or more, preferably 3 times or more, more preferably from 4 times to 50 times, still more preferably from 5 times to 30 times.

### A. First Embodiment

A manufacturing method for an emulsion according to a first embodiment of the present invention is a manufacturing method for an emulsion including circulating a mixed liquid containing a water phase and an oil phase in a circulation circuit including a plurality of tanks including a first tank and a second tank connected in parallel, a porous body, a liquid-delivering means, and circulation pipes for connecting these components so that the mixed liquid passes through the porous body a plurality of times, the circulation including (a) supplying the mixed liquid from the first tank to the circulation pipes toward the porous body, followed by the recovery of the mixed liquid that has passed through the porous body in the second tank, (b) switching a tank for supplying the mixed liquid to the circulation pipes to the second tank and switching a tank for recovering the mixed liquid that has passed through the porous body to the first tank at any time point when the remaining amount of the mixed liquid in the first tank becomes 10% or less of the entirety of the mixed liquid, and (c) supplying the mixed liquid from the second tank to the circulation pipes toward the porous body, followed by the recovery of the mixed liquid that has passed through the porous body in the first tank. The manufacturing method for an emulsion typically further includes (d) switching the tank for supplying the mixed liquid to the circulation pipes to the first tank and switching the tank for recovering the mixed liquid that has passed through the porous body to the second tank at any time point when the remaining amount of the mixed liquid in the second tank becomes 10% or less of the entirety of the mixed liquid. When the (a) and the (b), and the (c) and the (d) are alternately repeated until the number of times that the mixed liquid passes through the porous body reaches a desired number of times, an emulsion excellent in monodispersibility of its liquid droplets can be easily obtained.

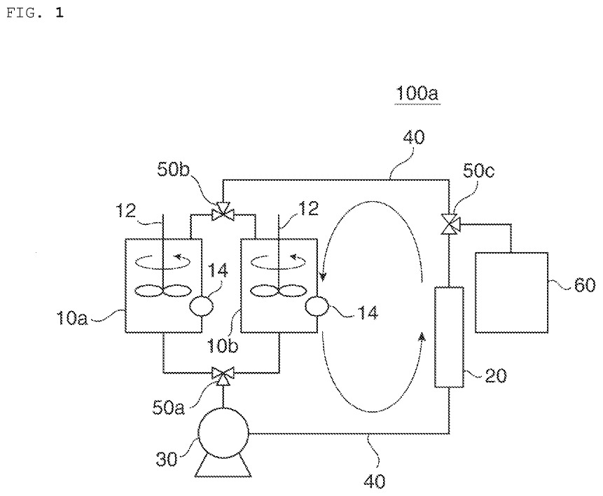

FIG. 1 is a schematic view for illustrating an example of a manufacturing apparatus for an emulsion that may be used in the above-mentioned manufacturing method for an emulsion. A manufacturing apparatus 100a for an emulsion illustrated in FIG. 1 includes: a first tank 10a and a second tank 10b for storing a mixed liquid containing a water phase and an oil phase, the tanks being connected in parallel; the porous body 20 for passing the mixed liquid therethrough to emulsify the water phase and the oil phase; the liquid-delivering means 30 for delivering the mixed liquid; and the circulation pipes 40 for connecting these components to form a circulation circuit. The manufacturing apparatus 100a can switch a supply tank for the mixed liquid to the first tank 10a or the second tank 10b with a supply tank-switching means (three-way valve in the illustrated example) 50a arranged on the downstream side (outlet side) of the first tank 10a and the second tank 10b, and can switch a recovery tank for the mixed liquid to the first tank 10a or the second tank 10b with a recovery tank-switching means (three-way valve in the illustrated example) 50b arranged on the upstream side (inlet side) of the first tank 10a and the second tank 10b. Thus, the supply tank and the recovery tank can be made different from each other. In addition, the manufacturing apparatus 100a is configured to recover the mixed liquid (emulsion) after its passage through the porous body 20 in the emulsion-storing tank 60 by switching a flow path specified by a discharge valve 50c.

Each of the tanks 10a and 10b preferably includes the stirring blade 12, and hence can keep the mixed liquid stored therein while stirring the liquid.

In addition, in the illustrated example, each of the tanks 10a and 10b includes a means (estimating means) 14 for estimating the amount of the mixed liquid stored therein. When the remaining amount of the mixed liquid in each of the tanks is measured or estimated with the estimating means 14, the timing at which the supply tank and the recovery tank are switched can be suitably determined. Examples of the estimating means 14 include various process sensors, such as a liquid surface sensor (e.g., a level sensor), a pressure sensor (e.g., a gauge pressure sensor or a differential pressure sensor), various flowmeters (e.g., Coriolis-type, diaphragm-type, ultrasonic, electromagnetic, and impeller flowmeters), a time-measuring means (e.g., a digital timer), a mass meter, a temperature sensor, a densimeter, a specific gravity meter, a turbidimeter, a pH meter, and a conductivity meter. Those means may be used alone or in combination thereof. Such combined means only needs to be achieved by appropriately combining the means in accordance with estimation accuracy and the safety of an entire process, and the estimation can be performed with various combinations. In addition, the place where the estimating means is arranged is not limited to the tanks.

The porous body 20 may be appropriately selected in accordance with the target characteristics of the emulsion. For example, when an oil-in-water (O/W) emulsion having oil droplets dispersed in its water phase is manufactured, a hydrophilic porous body is preferably used. In addition, when a water-in-oil (W/O) emulsion having water droplets dispersed in its oil phase is manufactured, a hydrophobic porous body is preferably used.

A material for forming the porous body is not limited as long as the material has desired hydrophilicity or hydrophobicity, and examples thereof include glass, a ceramic, silicon, a metal, and a polymer. In addition, the porous body may be any appropriate shape, such as a membrane-like shape, a plate-like shape, or a tubular shape.

The average hole diameter of the through-holes of the porous body may be appropriately selected in accordance with, for example, the target liquid droplet diameter of the emulsion, and the composition and viscosity of the mixed liquid to be passed through the porous body. In one embodiment, when the target average particle diameter of the liquid droplets of the emulsion is 5 μm, the average hole diameter of the through-holes may be, for example, from 1 μm to 20 μm, preferably from 5 μm to 10 μm. In addition, needless to say, from the viewpoint of obtaining an emulsion having high monodispersibility, the hole diameters of the through-holes of the porous body preferably have high uniformity.

The average particle diameter of the liquid droplets of the emulsion means an average diameter (sphere-equivalent diameter when the liquid droplets are not spheres) in a volume distribution, and for example, a value determined by a method (Coulter method) including converting an electric resistance change value at the time of the passage of the liquid droplets dispersed in an electrolytic solution through fine pores into a sphere-equivalent diameter may be used. Alternatively, for example, the following methods may each be adopted: a method including randomly sampling 2,000 particles of interest, observing the particles with a microscope, subjecting a taken image to digital processing, measuring individual particle diameters, and converting the measured values into sphere-equivalent diameters; and a measurement method including using a particle size-measuring apparatus of a light-shielding type for measuring the particle diameters on the basis of a change in quantity of transmitted light caused by the passage of the particles, or of a light-scattering type for specifying a particle size distribution through the measurement of a light scattering intensity changed by the particle diameters. However, among various approaches, an approach by which the particle diameter distribution of a sample having a narrow particle diameter distribution can be measured at the highest resolution is the Coulter method.

The liquid-delivering means 30 is typically a pump, and a metering pump is preferably used. When the pump causes pulsation, a pulsation-suppressing apparatus for suppressing the pulsation may be attached as required.

The circulation pipes 40 only need to be capable of connecting the first tank 10a and the second tank 10b, the porous body 20, and the liquid-delivering means 30 to form the circulation circuit, and may each be composed of any appropriate material.

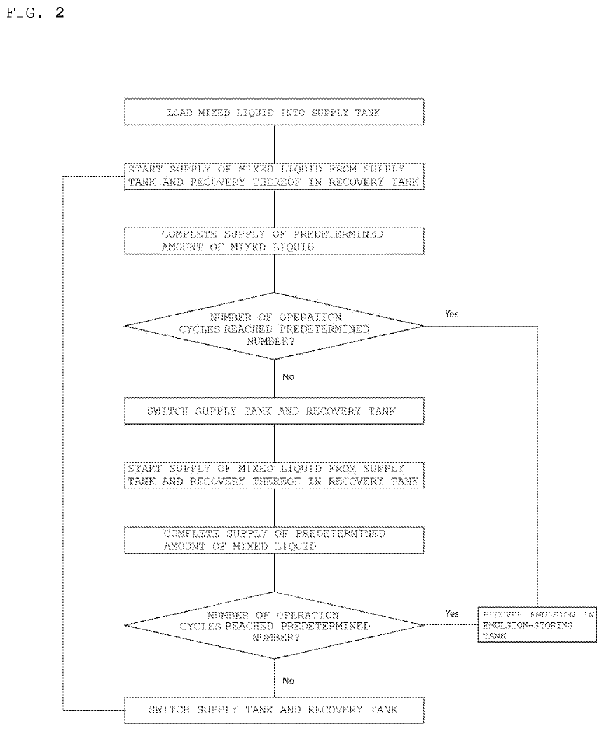

FIG. 2 is an example of a flow chart of the manufacturing method for an emulsion according to the first embodiment. As illustrated in FIG. 2, according to the manufacturing method of the first embodiment, in the circulation circuit in which the supply tank and the recovery tank are connected in parallel, a process from the start of the supply of the mixed liquid from the supply tank to the circulation pipes to the completion of the supply of a predetermined amount of the mixed liquid is defined as one cycle (one circulation), and the mixed liquid is circulated in the circulation circuit while the recovery tank and the supply tank are switched every cycle. After the number of the cycles has reached a predetermined number, the mixed liquid (emulsion) is extracted from the circulation circuit.

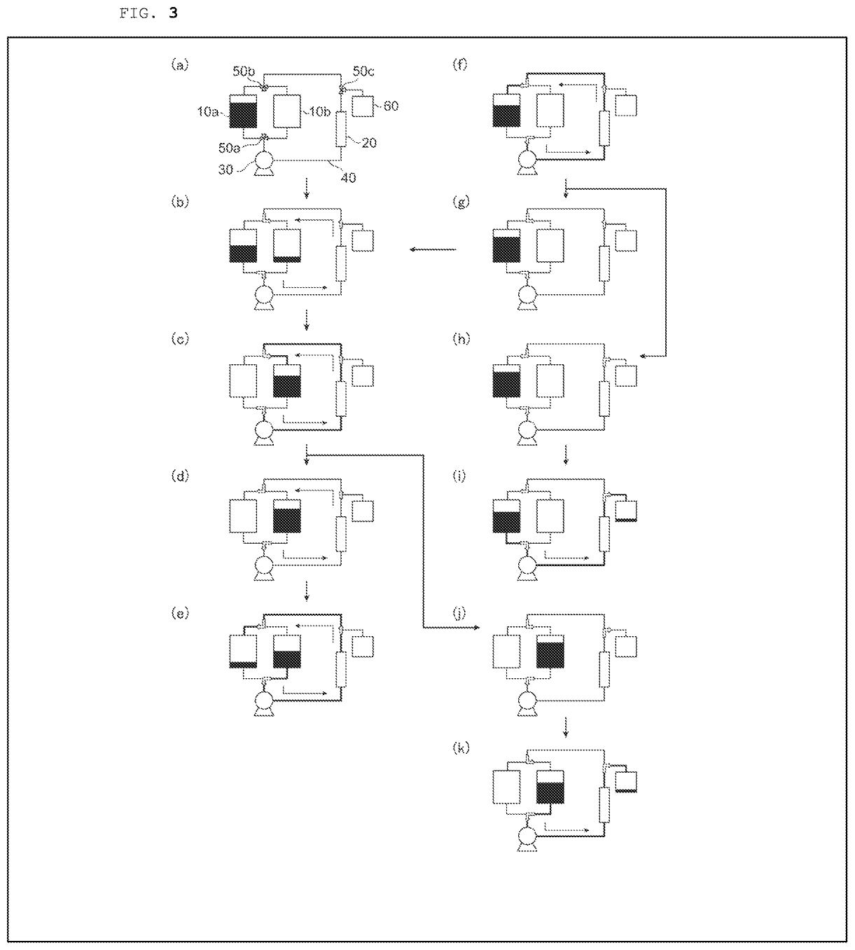

A specific process for the manufacturing method for an emulsion illustrated in the flow chart of FIG. 2 is described with reference to FIG. 3. In FIG. 3(b) to FIG. 3(i), an arrow illustrated on the circulation circuit indicates a flow path specified by a three-way valve. First of all, as illustrated in FIG. 3(a) and FIG. 3 (b), the mixed liquid containing the water phase and the oil phase is supplied from the first tank 10a filled with the mixed liquid to the circulation pipes 40, and the mixed liquid that has passed through the porous body 20 (first passage) is recovered in the second tank 10b. At the time point when the remaining amount of the mixed liquid in the first tank 10a becomes equal to or less than a predetermined amount (FIG. 3(c)), the three-way valves 50a and 50b are operated to switch the flow path, thereby switching the supply tank from the first tank 10a to the second tank 10b, and switching the recovery tank from the second tank 10b to the first tank 10a (FIG. 3(d)). At this time, it is preferred that the liquid-delivering means 30 be stopped, and the circulation of the mixed liquid be also stopped. Next, as illustrated in FIG. 3(e), the mixed liquid is supplied from the second tank 10b to the circulation pipes 40, and the mixed liquid that has passed through the porous body 20 (second passage) is recovered in the first tank 10a. At the time point when the remaining amount of the mixed liquid in the second tank 10b becomes equal to or less than the predetermined amount (FIG. 3(f)), the three-way valves 50a and 50b are operated to switch the flow path, thereby switching the supply tank from the second tank 10b to the first tank 10a, and switching the recovery tank from the first tank 10a to the second tank 10b (FIG. 3(g)). Also at this time, it is preferred that the liquid-delivering means 30 be stopped, and the circulation of the mixed liquid be also stopped. After that, again, as illustrated in FIG. 3(b), the mixed liquid is supplied from the first tank 10a to the circulation pipes 40, and the mixed liquid that has passed through the porous body 20 is recovered in the second tank 10b. While such switching of the supply tank and the recovery tank as illustrated in FIG. 3(b) to FIG. 3(g) above is repeated, the mixed liquid is circulated until the number of the cycles reaches the predetermined number. After that, as illustrated in FIG. 3(h) or FIG. 3(j), the three-way valve 50a is operated to switch the supply tank, and the three-way valve 50c is operated to switch the flow path. Thus, the mixed liquid is extracted from the circulation circuit and stored in the emulsion-storing tank 60 (FIG. 3(i) or FIG. 3(k)).

As described above, the switching of the supply tank and the recovery tank is performed at the time point when the remaining amount of the mixed liquid in the supply tank becomes equal to or less than the predetermined amount. Specifically, the switching of the supply tank and the recovery tank may be performed at any time point when the remaining amount of the mixed liquid in the supply tank becomes 10% or less, preferably 5% or less, more preferably 3% or less, still more preferably 1% or less of the entirety of the mixed liquid (in the illustrated example, the switching of the tanks is performed after the remaining amount of the mixed liquid in the supply tank has become 0%). When the supply tank and the recovery tank are switched after most of the mixed liquid has been discharged, the amount of the mixed liquid staying in the tank without being discharged to the circulation pipes can be significantly reduced. In one embodiment, at a time point after the lapse of a predetermined time from the detection of the fact that the amount of the mixed liquid in the supply tank has become equal to or less than a specified amount with the estimating means or the like, and/or a time point when the flow rate of the mixed liquid in the circulation pipes becomes equal to or less than a predetermined value (e.g., 0.1 L/min or less), it is regarded that the total amount of the mixed liquid in the supply tank is supplied to the circulation pipes (in other words, the remaining amount of the mixed liquid in the supply tank is 0%). Thus, the switching of the tanks can be performed. A specific example of the above-mentioned embodiment is described below. A differential pressure-type level sensor can be arranged near the bottom outlet of the supply tank to sense a liquid level in the tank, and a flowmeter can be arranged on the downstream side of the liquid-delivering means to judge whether or not the flow rate of the mixed liquid in the circulation pipes is in accordance with a preset flow rate. Accordingly, when the fact that a state in which the liquid level is equal to or less than a reference value, and the value indicated by the flowmeter is equal to or less than a reference value continues for a certain time period is measured with a digital timer, the fact that the remaining amount of the liquid in the tank is in the state of being close to zero can be estimated with high accuracy, and hence the timing at which the tanks are switched can be determined.

In the embodiment illustrated in FIG. 2 and FIG. 3, the number of times of the circulation (cycle number) of the mixed liquid may substantially correspond to the number of times that the mixed liquid has passed through the porous body. The number of times of the circulation (cycle number) of the mixed liquid may be twice or more, preferably 3 times or more, more preferably from 4 times to 50 times, still more preferably from 5 times to 30 times.

The mixed liquid contains the water phase and the oil phase, and preferably further contains an emulsifying agent and/or a polymer-based protective colloid agent. Part of the emulsifying agent or the polymer-based protective colloid agent may be added to the emulsion after the emulsification.

The water phase typically contains water. The water phase may be an aqueous solution having dissolved therein any appropriate water-soluble substance in accordance with, for example, purposes.

Any appropriate material that is not compatible with the water phase may be used as the oil phase. Specific examples of the oil phase include: plant oils, such as soybean oil, castor oil, and olive oil; animal oils, such as beef tallow and fish oil; mineral oils, such as an aromatic hydrocarbon, a paraffin-based hydrocarbon, and a naphthene-based hydrocarbon; fatty acids, such as linoleic acid and linolenic acid; organic solvents, such as hexane and toluene; liquid crystal compounds; and synthetic resins. Those materials may be used alone or in combination thereof.

The blending ratios of the water phase and the oil phase in the mixed liquid may be appropriately set in accordance with the target kind (O/W or W/O) of the emulsion.

An anionic surfactant, a cationic surfactant, a nonionic surfactant, an amphoteric surfactant, or the like is preferably used as the emulsifying agent.

Examples of the polymer-based protective colloid agent may include polyvinyl alcohol (PVA), polyvinyl pyrrolidone (PVP), methylcellulose (MC), hydroxyethylcellulose (HEC), hydroxypropylcellulose (HPC), hydroxypropylmethylcellulose (HPMC), starch, polyethylene glycol (PEG), and polyacrylic acid (PAA).

Each of the blending ratios of the emulsifying agent and the polymer-based protective colloid agent in the mixed liquid is, for example, from 0.1 wt % to 5.0 wt %, preferably from 0.2 wt % to 4.0 wt %, more preferably from 0.3 wt % to 3.0 wt % from the viewpoint of improving the monodispersibility, productivity, and the like of the liquid droplets.

The mixed liquid is preferably a preliminarily dispersed liquid having preliminarily dispersed therein in advance the water phase and the oil phase. The use of the preliminarily dispersed liquid can suppress an emulsification failure of the water phase and the oil phase, and can improve the emulsification rate thereof.

The average particle diameter of liquid droplets in the preliminarily dispersed liquid is larger than the average particle diameter that the liquid droplets of the emulsion are desired to have, and falls within the range of preferably from 1 times to 1,000 times, more preferably from 1 times to 100 times as large as the average hole diameter of the porous body. When the average particle diameter of the liquid droplets in the preliminarily dispersed liquid is excessively large as compared to the average hole diameter of the porous body, a pressure required for the emulsification may increase to apply a load exceeding the withstand pressure of a pipe joint portion or the pump.

A mechanical emulsification method including using, for example, a rotary blade-type homogenizer, an ultrasonic homogenizer, or a vortex mixer may be preferably adopted as a method of manufacturing the preliminarily dispersed liquid from the viewpoint of production efficiency.

The flow rate (flow rate per area of the porous body) of the mixed liquid in the circulation circuit is preferably from 0.01 L/(min·cm²) to 0.5 L/(min·cm²), more preferably from 0.02 L/(min·cm²) to 0.2 L/(min·cm²). When the mixed liquid is flowed at such flow rate, liquid droplets having a desired particle diameter can be suitably formed.

### B. Second Embodiment

A manufacturing method for an emulsion according to a second embodiment of the present invention is a manufacturing method for an emulsion including circulating a mixed liquid containing a water phase and an oil phase in a circulation circuit including a plurality of tanks including a first tank and a second tank connected in series, a porous body, a liquid-delivering means, and circulation pipes for connecting these components so that the mixed liquid passes through the porous body a plurality of times, the circulation including: supplying the mixed liquid from the first tank to the circulation pipes toward the porous body, followed by the recovery of the mixed liquid that has passed through the porous body in the second tank; and transferring the mixed liquid from the second tank to the first tank.

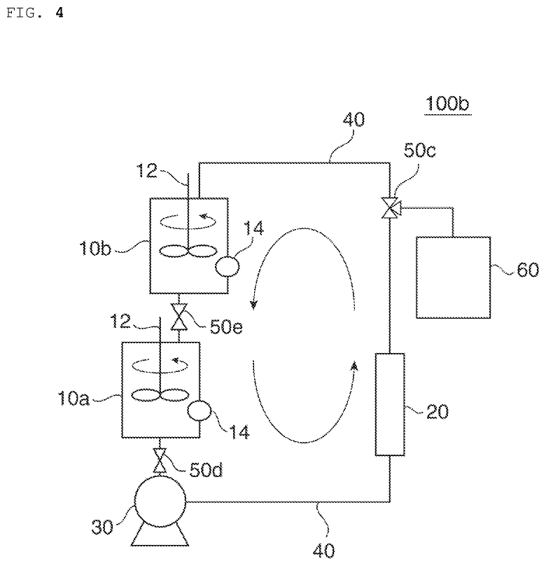

FIG. 4 is a schematic view for illustrating an example of a manufacturing apparatus for an emulsion that may be used in the above-mentioned manufacturing method for an emulsion. A manufacturing apparatus 100b for an emulsion is largely different from the manufacturing apparatus 100a in that the first tank 10a and the second tank 10b are connected in series. The same description as that of the section A may be applied to each of the tanks 10a and 10b, the porous body 20, the liquid-delivering means 30, and the circulation pipes 40.

In the manufacturing method of the second embodiment in the case where the manufacturing apparatus 100b is used, the first tank 10a is a supply tank, and the second tank 10b functions as a recovery tank. Specifically, the mixed liquid that has been supplied from the first tank 10a to the circulation pipes 40, and has passed through the porous body 20 is recovered in the second tank 10b. At the time point when the remaining amount of the mixed liquid in the first tank 10a becomes equal to or less than a predetermined amount (the time point is any time point when the remaining amount becomes typically 10% or less, preferably 5% or less, more preferably 3% or less, still more preferably 1% or less of the entirety of the mixed liquid, and may be after the remaining amount has become 0%), a valve 50d is closed, and then a valve 50e is opened to transfer the mixed liquid from the second tank 10b to the first tank 10a. When such circulation of the mixed liquid via the second tank is repeated a desired number of times, the target emulsion can be obtained. The same description as that of the first embodiment may be applied to the mixed liquid and conditions for the circulation. In this embodiment, the number of times of the circulation of the mixed liquid may correspond to the number of times that the mixed liquid has passed through the porous body. The number of times of the circulation of the mixed liquid may be twice or more, preferably 3 times or more, more preferably from 4 times to 50 times, still more preferably from 5 times to 30 times.

Although the preferred embodiments of the present invention have been described above, the present invention may be different from these embodiments. For example, one or more recovery sites for the mixed liquid may be arranged at any appropriate sites. When the emulsion-storing tanks are arranged at a plurality of sites, a liquid loss due to the remaining of the mixed liquid in the pipes can be reduced. In addition, for example, the following configuration may be adopted: a flow path is switched by arranging a two-way valve for each of the three pipes merging with each other, instead of using a three-way valve as the supply tank-switching means or the recovery tank-switching means. Further, an emulsion may be manufactured as follows: a circulation circuit including three or more tanks is used; a supply tank and a recovery tank for the mixed liquid are made different from each other; and the mixed liquid before its passage through the porous body and that after the passage are sequentially supplied to the circulation circuit.

In the manufacturing method of the present invention, the coefficient of variation (CV value) of the liquid droplets in the emulsion obtained by passing the mixed liquid through the porous body a plurality of times may be, for example, less than 0.40, and may be preferably 0.35 or less, more preferably 0.30 or less. The coefficient of variation is a value calculated by dividing the standard deviation of the particle diameters of the liquid droplets by the average thereof.

### EXAMPLES

The present invention is specifically described below by way of Examples, but the present invention is not limited to these Examples. In addition, “%” and “part(s)” refer to “wt %” and “part(s) by weight” unless otherwise specified.

### Example 1

### (Emulsion-Manufacturing Apparatus)

Such an emulsion-manufacturing apparatus as illustrated in FIG. 1, the apparatus having a pressure gauge arranged in a pipe between a pump and a porous body, was used. Specific specifications are as described below.

Pump: metering pump with no pulsation (manufactured by Tacmina Corporation, Smoothflow Pump TPL2ME-032)

Porous body: shirasu porous glass membrane (pipe form, membrane pore diameter: 10 μm, pipe diameter: 010 mm, membrane thickness: 0.7 mm, length: 125 mm)

First tank: pressure resistant tank with an air stirrer (20 L in volume)

Second tank: pressure resistant tank with an air stirrer (20 L in volume)

Pressure gauge: Bourdon tube pressure gauge

Pipe fittings: ISO ferrule union fittings, sanitary pipe (manufactured by Osaka Sanitary Co., Ltd.)

### (Preparation of Mixed Liquid)

Polyoxyalkylene alkyl ether (manufactured by DKS Co., Ltd., product name: “NOIGEN ET-159”) that was a nonionic surfactant was used as an emulsifying agent. The emulsifying agent and pure water were metered, and were then stirred in a vessel with a magnetic stirrer at 1,000 rpm and room temperature for 8 hours so that the emulsifying agent was completely dissolved in the pure water. Thus, a diluted water of the surfactant having a concentration of 10% was prepared.

4,776 Grams of a vegetable oil (manufactured by Kao Corporation, product name: “COCONAD MT-N”) was metered, and was sufficiently adapted to room temperature. The resultant was used as an oil phase.

400 Grams of the diluted water of the surfactant was added to the oil phase under a state in which the oil phase was stirred with an air stirring machine (200 rpm), followed by stirring for 1 minute. Next, 2,824 g of pure water was further added to the resultant, and the mixture was stirred for 5 minutes. Thus, a preliminarily dispersed mixed liquid (preliminarily emulsified O/W emulsion) was prepared.

A blending ratio (water phase (W)/oil phase (O)) between the water phase and the oil phase in the resultant mixed liquid was 40/60, and the content of the emulsifying agent therein was 0.5 wt %. In addition, the average particle diameter of the liquid droplets in the mixed liquid was 400 μm.

### (Membrane Emulsification Treatment)

8,000 Grams of the mixed liquid was transferred to the first tank of the emulsion-manufacturing apparatus. During a test, the air stirring machines of both the tanks were each continuously operated at 200 rpm. The mixed liquid was supplied from the first tank to the circulation pipes to be flowed in the circulation circuit (pump flow rate: 2.0 kg/min), and the mixed liquid after its passage through the porous body was recovered in the second tank. At the time point when the total amount of the mixed liquid was supplied from the first tank (the remaining amount of the mixed liquid in the first tank became 0% of the entirety of the mixed liquid), the pump was stopped, and a flow path specified by a three-way valve was switched to switch a supply tank to the second tank, and to switch a recovery tank to the first tank. After that, the operation of the pump was restarted to start the supply of the mixed liquid from the second tank, and the mixed liquid after the passage through the porous body was recovered in the first tank. Membrane emulsification treatment was performed by circulating the mixed liquid so that the number of times of membrane treatment (number of times of passage through the porous body) became 10 times while alternately switching the supply tank and the recovery tank for the mixed liquid as described above. After the completion of the membrane emulsification treatment, the mixed liquid was delivered from the metering pump under a state in which a discharge valve was released. Thus, an emulsion was recovered in an emulsion-storing tank.

During the membrane emulsification treatment, 5 mL of the mixed liquid that had been subjected to the membrane treatment once, 3 times, 5 times, 7 times, or 10 times was collected, and was evaluated for its particle diameter distribution.

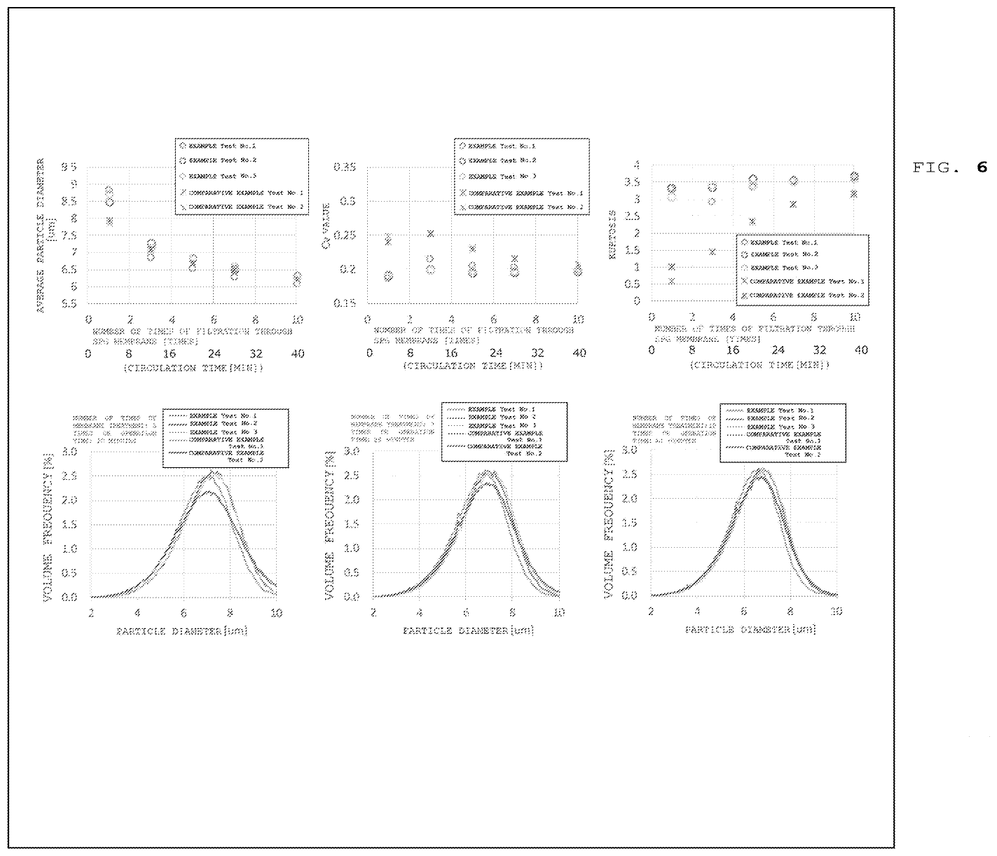

The foregoing test was performed a total of 3 times. The evaluation results of the particle diameter distributions in the 3 tests are shown in Table 1 and FIG. 6.

### Comparative Example 1

In the same emulsion-manufacturing apparatus as that of Example 1, the three-way valve was fixed so that a flow path passing only through the first tank was obtained. Thus, a one-tank circulation configuration in which only the first tank was used as the supply tank and the recovery tank for the mixed liquid was obtained.

8,000 Grams of a mixed liquid (preliminarily emulsified O/W emulsion) prepared in the same manner as in Example 1 was transferred to the first tank, and membrane treatment was performed by continuously flowing the mixed liquid in the circulation circuit (pump flow rate: 2.0 kg/min) for 40 minutes under a state in which the stirring machine was operated at 200 rpm. 5 Milliliters of the mixed liquid that had been treated for 4 minutes, 12 minutes, 20 minutes, 28 minutes, or 40 minutes was collected, and was evaluated for its particle diameter distribution. In the membrane treatment, 8,000 g of the mixed liquid is delivered at a flow rate of 2.0 kg/min, and hence the entirety of the mixed liquid may be subjected to the membrane treatment once in a treatment time of 4 minutes on average.

The foregoing test was performed a total of twice. The evaluation results of the particle diameter distributions in the 2 tests are shown in Table 1 and FIG. 6.

<<Method of Evaluating Particle Diameter Distribution>>

The particle diameter distribution of each of the mixed liquids collected in Example and Comparative Example above was measured by a Coulter counter method within 24 hours after the completion of the test. Thus, volume frequency distribution data on the particle diameters thereof, and the average and CV value of the particle diameters were obtained.

A kurtosis (volume frequency kurtosis) was calculated from the volume frequency distribution data with an Excel function.

To avoid noise data, statistical values were calculated by defining the range of from 1.5 μm to 12 μm in the volume frequency distribution data as a calculation range.

In addition, the measurement of the particle diameter distribution by the Coulter counter method was performed as follows: “Multisizer 3” (manufactured by Beckman Coulter Inc., a 20-micrometer aperture was used as a measuring tube) was used as a measuring apparatus; 150 ml of an electrolytic solution Isoton II was used as a dispersion medium; and the total particles in 60 seconds (time threshold value) was measured.

TABLE 1
Example

| | Test No. 1 | | | Test No. 2 | | | Test No. 3 | | |
|---|---|---|---|---|---|---|---|---|---|
| Number of | Average | | | Average | | | Average | | |
| times of | particle | | | particle | | | particle | | |
| membrane | diameter | CV | | diameter | CV | | diameter | CV | |
| treatment | (μm) | value | Kurtosis | (μm) | value | Kurtosis | (μm) | value | Kurtosis |
| 1 | 8.82 | 0.186 | 3.30 | 8.47 | 0.190 | 3.33 | 8.70 | 0.192 | 3.06 |
| 3 | 6.84 | 0.215 | 2.91 | 7.26 | 0.200 | 3.34 | 7.13 | 0.199 | 3.41 |
| 5 | 6.53 | 0.204 | 3.33 | 6.81 | 0.194 | 3.58 | 6.80 | 0.198 | 3.40 |
| 7 | 6.27 | 0.202 | 3.51 | 6.50 | 0.195 | 3.55 | 6.59 | 0.197 | 3.52 |
| 10 | 6.08 | 0.199 | 3.66 | 6.31 | 0.196 | 3.67 | 6.33 | 0.198 | 3.58 |

Comparative Example

| | Test No. 1 | | | Test No. 2 | | |
|---|---|---|---|---|---|---|
| | Average | | | Average | | |
| | particle | | | particle | | |
| Circulation | diameter | CV | | diameter | CV | |
| time (min) | (μm) | value | Kurtosis | (μm) | value | Kurtosis |
| 4 | 7.86 | 0.248 | 0.58 | 7.94 | 0.239 | 1.00 |
| 12 | 7.07 | 0.253 | 1.43 | 7.10 | 0.251 | 1.44 |
| 20 | 6.71 | 0.230 | 2.31 | 6.70 | 0.229 | 2.35 |
| 28 | 6.47 | 0.215 | 2.83 | 6.50 | 0.215 | 2.83 |
| 40 | 6.21 | 0.207 | 3.19 | 6.23 | 0.208 | 3.13 |

As shown in Table 1, an emulsion excellent in monodispersibility of its liquid droplets can be obtained by: recovering the mixed liquid that has passed through the porous body in the tank different from the tank serving as its supply source; and passing the mixed liquid through the porous body while switching the supply tank and the recovery tank.

### INDUSTRIAL APPLICABILITY

The manufacturing method for an emulsion of the present invention is suitably used in the manufacture of an emulsion containing liquid droplets having high monodispersibility.

### REFERENCE SIGNS LIST

10 tank
20 porous body
30 pump 40 circulation pipe
100 manufacturing apparatus for emulsion
200 manufacturing apparatus for emulsion

1. A manufacturing method for an emulsion, comprising circulating a mixed liquid containing a water phase and an oil phase in a circulation circuit including a plurality of tanks, a porous body, a liquid-delivering means, and circulation pipes configured to connect the tanks, the porous body, and the liquid-delivering means so that the mixed liquid passes through the porous body a plurality of times,
wherein a tank to supply the mixed liquid to the circulation pipes toward the porous body and a tank to recover the mixed liquid that has passed through the porous body are different tanks.

2. The manufacturing method according to claim 1,
wherein the plurality of tanks include a first tank and a second tank connected in parallel, and
wherein the circulating the mixed liquid includes
(a) supplying the mixed liquid from the first tank to the circulation pipes toward the porous body, followed by recovery of the mixed liquid that has passed through the porous body in the second tank,
(b) switching the tank to supply the mixed liquid to the circulation pipes to the second tank and switching the tank to recover the mixed liquid that has passed through the porous body to the first tank at any time point when a remaining amount of the mixed liquid in the first tank becomes 10% or less of an entirety of the mixed liquid,
(c) supplying the mixed liquid from the second tank to the circulation pipes toward the porous body, followed by recovery of the mixed liquid that has passed through the porous body in the first tank, and
(d) switching the tank to supply the mixed liquid to the circulation pipes to the first tank and switching the tank to recover the mixed liquid that has passed through the porous body to the second tank at any time point when a remaining amount of the mixed liquid in the second tank becomes 10% or less of the entirety of the mixed liquid.

3. The manufacturing method according to claim 2, wherein the circulating the mixed liquid includes alternately repeating the (a) and the (b), and the (c) and the (d).

4. The manufacturing method according to claim 1,
wherein the plurality of tanks include a first tank and a second tank connected in series, and
wherein the circulating the mixed liquid includes
supplying the mixed liquid from the first tank to the circulation pipes toward the porous body, followed by recovery of the mixed liquid that has passed through the porous body in the second tank, and
transferring the mixed liquid from the second tank to the first tank.

5. The manufacturing method according to claim 1, wherein the mixed liquid is a preliminarily dispersed liquid having preliminarily dispersed therein the water phase and the oil phase.

6. The manufacturing method according to claim 1, wherein the manufacturing method is a manufacturing method for an oil-in-water emulsion having oil droplets dispersed in a water phase thereof.

7. The manufacturing method according to claim 1, wherein the circulating the mixed liquid is performed so that the mixed liquid passes through the porous body 3 or more times.

8. A manufacturing apparatus for an emulsion, comprising:
two or more tanks to store a mixed liquid containing a water phase and an oil phase;
a porous body to pass the mixed liquid therethrough to emulsify the water phase and the oil phase;
a liquid-delivering means for delivering the mixed liquid; and
circulation pipes configured to connect the tanks, the porous body, and the liquid-delivering means to form a circulation circuit,
wherein the two or more tanks include two or more tanks connected in parallel,
wherein a downstream side of the two or more tanks connected in parallel has arranged thereon a supply tank-switching means for switching a tank to supply the mixed liquid to the circulation pipes, and
wherein an upstream side of the two or more tanks connected in parallel has arranged thereon a recovery tank-switching means for switching a tank to recover the mixed liquid from the circulation pipes.

9. The manufacturing apparatus according to claim 8, wherein the supply tank-switching means and the recovery tank-switching means are configured so as to be capable of switching the tanks so that the tank to supply the mixed liquid and the tank to recover the mixed liquid are different tanks.

10. A manufacturing apparatus for an emulsion, comprising:
two or more tanks to store a mixed liquid containing a water phase and an oil phase;
a porous body to pass the mixed liquid therethrough to emulsify the water phase and the oil phase;
a liquid-delivering means for delivering the mixed liquid; and
circulation pipes configured to connect the tanks, the porous body, and the liquid-delivering means to form a circulation circuit,
wherein the two or more tanks include two or more tanks connected in series.

11. The manufacturing apparatus according to claim 8, further comprising a means for estimating an amount of the mixed liquid stored in each of the tanks.

12. The manufacturing apparatus according to claim 10, further comprising a means for estimating an amount of the mixed liquid stored in each of the tanks.
